(19) United States
(12) Patent Application Publication
(10) Pub. No.: US 2006/0191561 A1
(43) Pub. Date: Aug. 31, 2006

(54) Undercarriage washer for self-serve car wash bay

(76) Inventors: Joseph A. Mey, Sparta, MI (US); Arthur C. Olen JR., Jenison, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 11/343,330

(22) Filed: Jan. 31, 2006

Related U.S. Application Data
(60) Provisional application No. 60/648,507, filed on Jan. 31, 2005.

(51) Int. Cl. B08B 3/00; B08B 3/12

(52) U.S. Cl. 134/123; 134/172; 134/198; 134/103.2

(57) ABSTRACT

An undercarriage carwash system for use in a self-serve carwash bay includes a housing, a conduit with a plurality of nozzles, and a control. The bay has a support surface at which a vehicle is parked during the washing of the vehicle, and has a pressurized fluid system for discharging pressurized fluid via at least one spraying device of the bay to wash the vehicle. The housing is positioned on the support surface of the bay and entirely above the plane of the support surface. The conduit is positioned within the housing and is connected to the pressurized fluid system of the carwash bay. The nozzles are directed to discharge fluid from the pressurized fluid system of the carwash bay to an underside of a vehicle at the support surface of the bay. The control selectively provides pressurized fluid to the conduit for discharging the fluid by said nozzles.

### CROSS REFERENCE TO RELATED APPLICATION

The present application claims the benefit of U.S. provisional application, Ser. No. 60/648,507, filed Jan. 31, 2005, which is hereby incorporated herein by reference in its entirety.

### FIELD OF THE INVENTION

The present invention relates generally to self-serve carwash bays and, more particularly, to self-serve carwash bays that are selectively operable to provide different washing options.

### BACKGROUND OF THE INVENTION

Self-serve carwash bays are known and allow a user to drive their vehicle into the bay and onto the floor of the bay to wash the vehicle. The user may insert money or tokens or the like into a meter device and may select one or more options available to the user, such as a wand option or brush option or different cleaning solutions or the like. The user may then wash the car while pressurized water (and/or solutions or the like) is sprayed from a wand or brush device of the bay. In order to clean the underside of the vehicle in such self-serve carwash bays, the user has to crouch or kneel down and reach the wand at least partially under the vehicle to direct the wand's spray upward at the underside of the vehicle. Such a procedure is difficult to do, particularly for people that have back problems, and may result in the user getting their knees or other body parts wet while they crouch down and spray the undercarriage of the vehicle. Also, such a procedure may not clean the entire undercarriage of the vehicle, particularly along the centerline of the vehicle where it may be hard to reach with the wand.

### SUMMARY OF THE INVENTION

The present invention provides an undercarriage carwash system for implementation at a self-serve carwash bay, such as at or into an existing self-serve carwash bay. The undercarriage carwash system is positioned on and above the floor or support surface of the bay and connected to the pressurized fluid system of the bay. The undercarriage carwash system thus may be selectively activated by a user to wash the underside of their vehicle when the vehicle is parked in the self-serve carwash bay.

According to an aspect of the present invention, an undercarriage carwash system for use in a self-serve carwash bay includes a housing, a conduit with a plurality of nozzles, and a control. The self-serve carwash bay has a substantially planar or flat floor at which a vehicle is parked during the washing of the vehicle. The self-serve carwash bay has a pressurized fluid system for discharging pressurized fluid via at least one spraying device of the bay to wash the vehicle. The housing is positioned on the floor of the carwash bay and entirely above the floor surface or plane of the floor of the carwash bay. The conduit is positioned within the housing and is connected to the pressurized fluid system of the self-serve carwash bay. The nozzles are directed to discharge fluid from the pressurized fluid system of the self-serve carwash bay toward an underside of a vehicle in the carwash bay and supported on the floor of the carwash bay. The control selectively provides pressurized fluid to the conduit for discharging the fluid by the nozzles.

The housing and the conduit are preferably positioned lengthwise along a length dimension of the carwash bay, with the housing and the conduit being spaced from a sidewall of the carwash bay. A supply conduit may be connected between the conduit and the pressurized fluid system. The supply conduit may extend along the floor of the carwash bay and generally between the conduit and a sidewall of the carwash bay. A supply line housing may substantially contain the supply conduit. The housing and the supply line housing preferably comprise sloped sidewalls, and the housing preferably includes a grating portion at an upper end thereof, whereby the nozzles are directed to discharge fluid through the grating portion.

According to another aspect of the present invention, a method of installing an undercarriage carwash system at an existing self-serve carwash bay includes providing a housing and a conduit within the housing. The self-serve carwash bay has a substantially planar or flat floor and opposite sidewalls extending lengthwise along opposite side regions of the floor. The conduit has a plurality of nozzles positioned therealong, and is positioned on or above and supported at the surface of the floor of the carwash bay and in a lengthwise direction of the carwash bay. A supply housing and a supply conduit are provided at the floor of the carwash bay and between the conduit and one of the sidewalls of the carwash bay. The supply conduit is connected to the conduit and to a pressurized fluid system of the carwash bay. A selectively operable control device is provided to selectively provide pressurized fluid to the supply conduit.

Therefore, the present invention provides an undercarriage carwash system or function to a self-serve carwash bay, such as an aftermarket or add-on to an existing self-serve carwash bay or the like. The undercarriage carwash system includes conduits or pipes that are substantially contained within and protected by housing portions and that are positioned along the floor of the carwash bay. The housing portions have sloped sidewalls to limit tripping over the housing portions and to allow a vehicle to readily driven over the housing portions and the conduits/pipes at the floor of the carwash bay. The present invention thus provides an undercarriage carwash system at a self-serve carwash bay that is selectively operable to wash or spray the undercarriage of a vehicle so that a user at the carwash bay need not crouch or kneel down to manually direct a wand or nozzle under the vehicle to wash the underside of the vehicle.

These and other objects, advantages, purposes and features of the present invention will become apparent upon review of the following specification in conjunction with the drawings.

### BRIEF DESCRIPTION OF THE DRAWINGS

FIG. 1 is a plan view of an undercarriage carwash system in accordance with the present invention;

FIG. 2 is a sectional view of the undercarriage carwash system taken along the line II-II in FIG. 1; and

FIG. 3 is another plan view of an undercarriage carwash system of the present invention.

### DESCRIPTION OF THE PREFERRED EMBODIMENTS

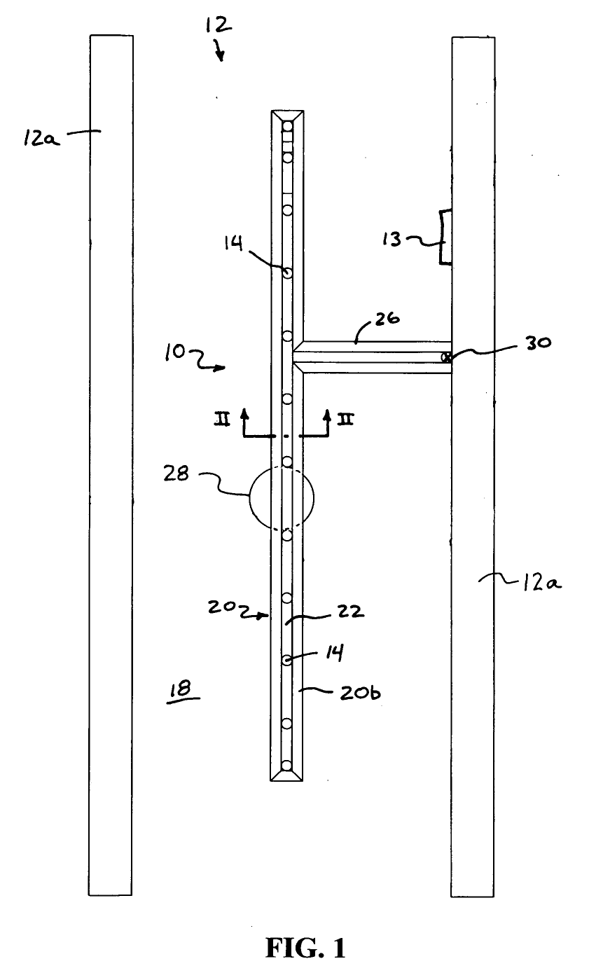

Referring now specifically to the drawings and the illustrative embodiments depicted therein, an undercarriage carwash system 10 is positionable at a self-serve carwash bay 12 (FIGS. 1-3). The undercarriage carwash system 10 includes a plurality of nozzles 14 positioned along a discharge conduit or pipe 16 such that pressurized water (and/or other cleaning solutions and the like) may be sprayed from the nozzles generally upward to clean the undercarriage of a vehicle (not shown) parked or positioned at or in the carwash bay 12 and generally over the undercarriage carwash system 10. The undercarriage carwash system 10 is positioned on the floor or support surface 18 of the bay 12, such that no re-working or channeling of the bay floor is required to implement the undercarriage carwash system at an existing self-serve carwash bay. A user thus may drive their vehicle into the self-serve bay such that the vehicle is positioned generally over the undercarriage carwash system, and then may actuate the undercarriage carwash system to spray and clean the undercarriage of the vehicle, without having to manually use a spray wand or the like that is typically available at known self-serve carwash bays. The user may optionally select the undercarriage carwash feature at a control panel or meter 13 or the like of the self-serve carwash bay 12.

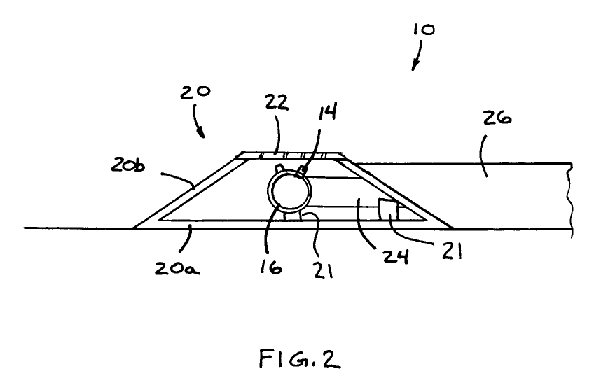

Undercarriage carwash system 10 includes a discharge conduit housing or housing portion 20 that substantially encases the pipe 16 and provides a protective housing for the pipe along the floor 18 of the bay 12. As best shown in FIG. 2, the housing 20 may have a base 20a that is positioned at and supported on the floor or support surface 18, and angled walls 20b that extend upward and inward to provide sloped side surfaces of the housing portion 20. The sloped side walls 20b limit tripping over the undercarriage carwash system by a person in the bay. A grate or screen or grating cover 22 or the like may be positioned at an upper portion of the housing 20, so that the water discharged or sprayed from the nozzles 14 may spray or flow through the screen or grating cover 22 and to the underside of the vehicle positioned at the undercarriage carwash system. Preferably, the housing 20 and cover 22 comprise a durable and strong metallic material, such as steel or the like, and may be coated with a non-slip, durable coating, such as LINE-X® or the like, or may otherwise have a suitable non-slip coating established thereon. Thus, the housing and cover may be substantially durable and may limit slipping by a user who may step on the housing or cover while washing their car. Such a non-slip coating or material is desired since the housing and cover will get wet during use of the carwash bay and thus may otherwise become slippery to a person stepping on the housing and cover.

Discharge pipe 16 extends longitudinally along the housing 20 and below cover 22, with the nozzles 14 directed generally upward to spray/discharge water (and/or other solutions and the like) through the cover 22. The nozzles 14 may be spaced along the pipe 16 and may be directed in different radial and longitudinal directions, such as to one side and/or the other and generally straight upward and/or forward and/or rearward, so as to provide a spray pattern that substantially covers the underside of a vehicle at the undercarriage carwash system. For example, the nozzles may function to spray upwards and radially outward from the discharge pipe, such as in a fan pattern that reaches about three feet to either side so as to substantially spray the underside of a vehicle positioned over the discharge pipe (so as to cover or spray an area that is approximately 5½ feet to 6½ feet wide or thereabouts). The nozzles may comprise high pressure nozzles with a fan or conical spray pattern to enhance the coverage of the water sprayed by or discharged from the nozzles. The nozzles 14 and pipe 16 thus may be positioned in a lengthwise manner along the carwash bay (and at or above the floor or support surface) so as to extend substantially along the underside of a vehicle when a vehicle is driven into the carwash bay.

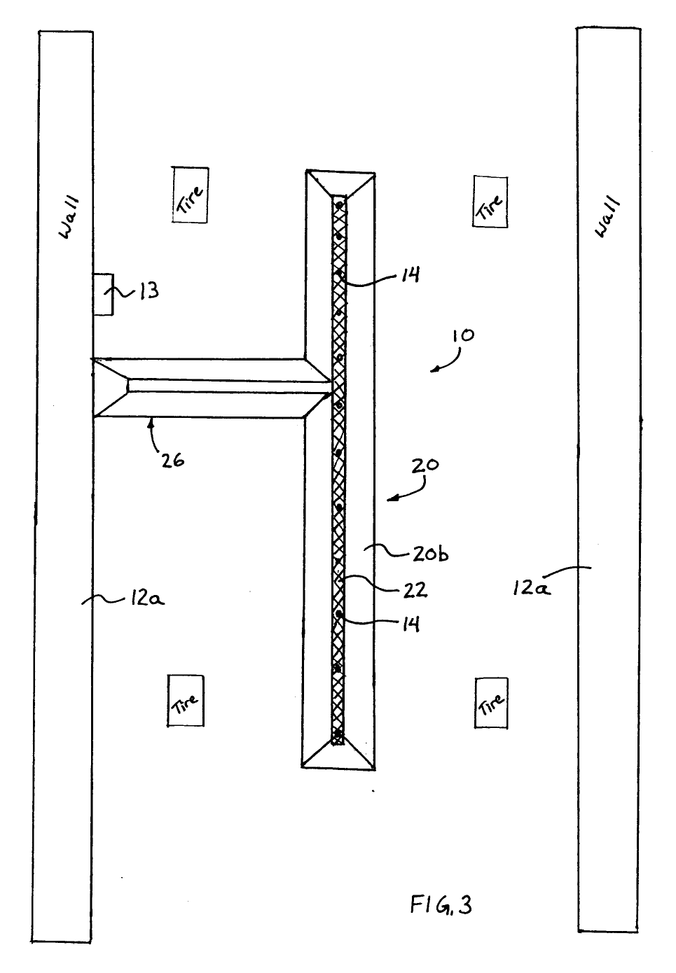

The pipe 16 may receive the water supply from a supply conduit or pipe 24 (FIG. 3), which may join or connect to the pipe 16 at one end and to a water supply of the carwash bay at the other end. In the illustrated embodiment, the supply pipe 24 extends from a wall 12a of the carwash bay 12 and generally along or above the floor or support surface 18 of the bay 12 and to the housing 20 for connection to the pipe 16 (such as at a T-connection or joint or the like). The supply pipe 24 is positioned within and along a supply housing or housing portion 26 to house and protect the supply pipe 24.

The supply housing 26 may be substantially similar to the housing 20, discussed above, so that it may have a base (not shown), tapered or angled sidewalls 26a and a cover portion 26b. The sidewalls 26a are preferably angled to limit tripping by a user and to facilitate driving a vehicle over the housing 26 as the vehicle is moved into position generally or substantially over the pipe 16 and nozzles 14. Because the supply conduit or pipe does not include nozzles for spraying the underside of the vehicle, the cover portion 26b need not be a grating material, but could be a solid plate or the like, without affecting the scope of the present invention. Housing 26 may also have a substantially non-slip coating established thereon to limit slipping by a user that may step on the housing while washing their car. The housing 26 is sufficiently durable to withstand a vehicle driving over the housing 26 as the vehicle is driven into or out from the carwash bay 12.

Preferably, both housings 20, 26 are durable to withstand the weight of a vehicle driving over them without buckling or substantial flexing, so that the conduits or pipes 16, 24 will not be damaged as a vehicle is driven into and out from and parked in the self-serve carwash bay, and as the housings are stepped on by a user of the self-serve carwash bay as the user walks around their vehicle during the self-serve washing process. The base portions of the housings or casings may be set directly onto the support surface or floor of the self-serve carwash bay, and may be secured thereto, such as via adhesive or fasteners or the like. The housings or casings may be shimmed or adjusted (such as via adjustable feet or support elements along the base portions of the housings) to substantially match the contours of the support surface or floor so that the pipes or conduits may be positioned substantially horizontally along the support surface or floor of the self-serve carwash bay. The conduits or pipes may be positioned within the housings and may be supported via brackets 21 (FIG. 2) or the like that extend from the base portions or side walls of the respective housings, so that the conduits or pipes are substantially fixedly positioned within and along the respective housings. Optionally, the pipes or conduits may rest on or be supported at the base portion of the respective housings, or may rest on the floor or support surface of the self-serve carwash bay (for applications where the housings may not have a base portion and the side walls may rest on and/or be attached to the support surface of the carwash bay), without affecting the scope of the present invention.

The supply pipe 24 is connected to a control valve 30 or the like of the pressurized water system of the carwash bay, so that actuation of the control valve causes pressurized water or other fluid to flow through the supply pipe 24, to the pipe 16 and out the nozzles 14 to wash the undercarriage of a vehicle. The control valve may be controlled by a control system or control device or control panel 13 or the like of the carwash bay, which may actuate or open the valve (such as via actuation of a solenoid valve or the like) to provide the undercarriage wash feature in response to a selection by a user of such feature and/or insertion of the appropriate money or tokens into a control panel or meter or the like at the carwash bay. Such control meters are capable of selectively providing multiple functions or features at the self-serve carwash bay, such as providing pressurized water to a wand or brush or other washing attachment or device at the self-serve carwash bay. Upon selection of the desired wash functions or features, a user may proceed to use the desired/selected devices of the carwash bay to wash the vehicle via the pressurized fluid that is selectively provided at the desired/selected device (such as a wand or brush or the like, or such as the undercarriage carwash system of the present invention). The carwash bay also includes a wash bay drain 28 for draining the water from the bay after it is dispensed or sprayed or discharged by the nozzles of the undercarriage carwash system and/or the other nozzles or spraying or washing devices of the carwash bay.

As can be seen in FIG. 3, the discharge pipe and discharge housing may be substantially linear and may be arranged lengthwise along the carwash bay and generally parallel to the walls of the carwash bay, while the supply pipe and supply housing may be arranged along the support surface and generally orthogonal or perpendicular to the wall of the carwash bay and to the discharge pipe and discharge housing. However, other arrangements or configurations of the discharge pipe/housing and the supply pipe/housing may be implemented without affecting the scope of the present invention. For example, the discharge pipe and housing may not comprise a straight or substantially straight conduit or pipe, but may be curved in an alternating wave-like pattern to enhance the coverage of the spray of the nozzles during operation of the undercarriage wash system, or the discharge pipe may comprise two or more pipes, with some pipes being arranged to extend from a main discharge pipe (such as laterally toward the walls of the carwash bay) to again enhance the spray coverage of the system. The discharge cover (or covers for applications where there may be two or more discharge conduits or pipes) is configured to accommodate the shape or curve of the discharge pipe, and may be correspondingly curved or may be wide enough to substantially encase the curved discharge pipe therein.

Although shown and described as having a plurality of nozzles directed in selected or predetermined directions when the pipe is positioned at or above the support surface of the existing car wash bay, it is envisioned that the discharge pipe 16 and nozzles 14 may be movable during use (such as in an oscillating manner about a longitudinal axis of the pipe) to direct the pressurized fluid in different directions during operation of the washing device. For example, the pipe 16 may be mounted on bearing blocks or the like, and the water flow through the supply pipe and into the discharge pipe may cause oscillation of the discharge pipe about its longitudinal axis (such as by utilizing aspects of conventional lawn sprinklers that oscillate back and forth as water flows through them). Other means for enhancing the range and coverage of the spray nozzles may be implemented, without affecting the scope of the present invention.

In a preferred embodiment, the self-serve undercarriage carwash system of the present invention may be designed with ¼ inch LINE-X® coated diamond plated steel safety ramps, ½ inch annealed stainless steel pipe, 1⅛ inch steel grating, preferably also coated with LINE-X®. The pipe may be drilled and tapped and is preferably equipped with a plurality of high pressure nozzles, such as nozzles capable of spraying water at up to about 1000 p.s.i. or thereabouts (or more or less as desired, depending on the particular application). In an exemplary embodiment, the discharge conduit cover may measure about 14 inches wide (at the base of the discharge conduit cover) by about 12½ feet long and about 2 inches high. The supply line protective cover may measure about 8 inches wide (at the base of the supply conduit cover) and the length of the protective cover may be dependent on the distance from the center of the wash bay to the spraying portion so that the protective cover may extend substantially the entire distance between the discharge conduit cover and the wash bay wall. Although described as having the dimensions and comprising the materials described above, clearly, the housing portions or covers and pipes may have other dimensions and may comprise other materials, such as stainless steel, galvanized metal and/or the like, without affecting the scope of the present invention.

Therefore, the present invention provides an undercarriage wash system for a self-serve carwash bay. The undercarriage wash system is positioned on the floor of the bay and thus may be readily implemented at an existing carwash bay. The housings and pipes/nozzles may be readily positioned on or supported at the surface of the existing floor of a self-serve carwash bay, and the supply pipe may be connected to an appropriate control valve of the existing pressurized fluid/water system of the carwash bay. A user may then drive their vehicle into the self-serve carwash bay (and over the wash system of the present invention) and may select the appropriate or desired options at the control panel or meter and insert the appropriate payment, whereby the user may wash the exterior of their vehicle, such as with a wand or the like, while (or before or after) the undercarriage carwash system washes or sprays the underside of the vehicle.

The undercarriage carwash device or system of the present invention is thus used in self-serve carwash bays or facilities. The system is adaptable to new and existing self-serve carwash bays and is positionable on or over a floor surface of a self-serve carwash bay. As the vehicle is driven into the self-serve carwash bay, the vehicle may be driven over a portion of the undercarriage carwash system on the floor of the bay. The undercarriage carwash system is positioned generally in the center of the carwash bay, so that it will be substantially directly under the vehicle parked in the bay, such that the vehicle would be parked or stationary over the nozzles of the undercarriage carwash system. The customer may then insert the appropriate amount of funds (such as coins, dollar bills or credit/debit card or tokens or the like) and select the undercarriage wash option on the timed meter. Other various options, such as, for example, foaming brush, wax, and/or the like, may also be selected by the user or customer. After the selection or selections is/are made, the meter sends a signal to the appropriate switches or valves, which activate the selected features or devices, including the undercarriage carwash system, which may use high-pressure spray nozzles to then spray the undercarriage of the vehicle. The spray nozzles direct water and/or a degreaser or other pressurized fluid or cleaning solution to the underside of the vehicle, flushing away the dirt, salt and grime from the undercarriage of the vehicle.

Because the undercarriage wash system of the present invention is positioned beneath the vehicle when the vehicle is parked in the self-serve wash bay, the vehicle owner will no longer have to stoop or bend to wash the undercarriage of the vehicle, making the system much more appealing to chronic back pain sufferers. The vehicle owner will also no longer get wet knees from trying to use the spray wand to wash the undercarriage. Because the undercarriage carwash system of the present invention is positioned on the floor of the bay and entirely on or above the floor of the bay, the undercarriage carwash system may be readily installed in an existing self-serve carwash bay.

Changes and modifications to the specifically described embodiments may be carried out without departing from the principles of the present invention, which is intended to be limited only by the scope of the appended claims, as interpreted according to the principles of patent law.

The embodiments of the invention in which an exclusive property or privilege is claimed are defined as follows:

1. An undercarriage carwash system for use in a self-serve carwash bay, the self-serve carwash bay having a support surface at which a vehicle is parked during the washing of the vehicle, the self-serve carwash bay having a pressurized fluid system for discharging pressurized fluid via at least one spraying device of the bay to wash the vehicle, said undercarriage carwash system comprising:
a housing, said housing positioned on the support surface of the carwash bay and entirely above the plane of the support surface of the carwash bay;
a conduit with a plurality of nozzles, said conduit being positioned within said housing and being connected to the pressurized fluid system of the self-serve carwash bay, said nozzles being directed to discharge fluid from the pressurized fluid system of the self-serve carwash bay to an underside of a vehicle at the support surface of the carwash bay; and
a control for selectively providing pressurized fluid to said conduit for discharging the fluid by said nozzles.

2. The undercarriage carwash system of claim 1, wherein said housing and said conduit are positioned lengthwise along a length dimension of the carwash bay, said housing and said conduit being spaced from a sidewall of the carwash bay.

3. The undercarriage carwash system of claim 2 including a supply conduit connected between said conduit and the pressurized fluid system, said supply conduit extending along the support surface of the carwash bay and generally between said conduit and a sidewall of the carwash bay.

4. The undercarriage carwash system of claim 3 including a supply line housing that substantially contains said supply conduit.

5. The undercarriage carwash system of claim 4, wherein said housing and said supply line housing comprise sloped sidewalls.

6. The undercarriage carwash system of claim 1, wherein said housing comprises sloped sidewalls.

7. The undercarriage carwash system of claim 6, wherein said housing includes a grating portion at an upper end thereof, said nozzles being directed to discharge fluid through said grating portion.

8. The undercarriage carwash system of claim 1, wherein said housing is coated with a non-slip coating.

9. A method of installing an undercarriage carwash system at an existing self-serve carwash bay, the self-serve carwash bay having a support surface and opposite sidewalls extending lengthwise along the support surface, said method comprising:
providing a discharge conduit housing and a discharge conduit within said discharge conduit housing, said discharge conduit having a plurality of nozzles positioned therealong;
positioning said discharge conduit housing on the support surface of the carwash bay;
providing a supply housing and a supply conduit;
positioning said supply housing and said supply conduit on the support surface of the carwash bay and between the discharge conduit and one of the sidewalls of the carwash bay;
connecting said supply conduit to said discharge conduit and to a pressurized fluid system of the carwash bay; and
providing a selectively operable control device to selectively provide pressurized fluid to said supply conduit.

10. The method of claim 9, wherein said discharge conduit housing and said supply housing comprise sloped sidewalls.

11. The method of claim 10, wherein said discharge conduit housing includes a grating portion at an upper end thereof, said nozzles being directed to discharge fluid through said grating portion.

12. The method of claim 9, wherein positioning said discharge conduit housing on the support surface of the carwash bay comprises positioning said discharge conduit in a lengthwise direction of the carwash bay.

13. The method of claim 12, wherein positioning said supply housing and said supply conduit on the support surface of the carwash bay comprises positioning said supply housing and said supply conduit generally orthogonal to the wall of the carwash bay and to the discharge conduit.

14. The method of claim 9, wherein providing a discharge conduit housing comprises providing a discharge conduit housing with a non-slip coating established thereon.

15. The method of claim 9, wherein providing a supply housing comprises providing a supply housing with a non-slip coating established thereon.
